(19) United States
(12) Patent Application Publication
(10) Pub. No.: US 2007/0172034 A1
(43) Pub. Date: Jul. 26, 2007

(54) Method of providing a ring-back tone service in a mobile communication system

(76) Inventor: Sung Kyu Jung, Seoul (KR)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 10/556,205

(22) PCT Filed: May 28, 2004
(86) PCT No.: PCT/KR04/01275

§ 371 Date: Jan. 22, 2007

(30) Foreign Application Priority Data
May 29, 2003 (KR) 10-2003-0034440

(51) Int. Cl. H04M 1/24; H04M 3/22

(52) U.S. Cl. 379/1.01

(57) ABSTRACT

There is provided a method of providing a ring-back tone service in a mobile communication system by extending such service to a calling party even when only the calling party has subscribed to the service. The conventional ring-back tone service, however, can be provided only when the called party has subscribed to the service.

### TECHNICAL FIELD

The present invention generally relates to a method of providing a ring-back tone service in a mobile communication system, and more particularly to a method of providing a ring-back tone service in a mobile communication system through extending such service to a calling party even though only the calling party has subscribed to the service.

### BACKGROUND ART

According to the currently existing ring-back tone service, a calling party can hear music or sound that a called party, who subscribed to the corresponding service, chose until a call connection is established. Thus, such type of service can be provided only after the called party has subscribed thereto.

FIG. 1 shows a diagram for providing a ring-back tone service according to the prior art. FIG. 2 shows a flowchart for providing the ring-back tone service according to the prior art.

As shown in FIGS. 1 and 2, according to the conventional ring-back tone service, a destination switch 50 requests to a Home Location Register (HLR) 20 whether a called party has subscribed to a ring-back tone service upon receiving an Integrated Services Digital Network User Part Initial Address Message (ISUP-LAM) from an originating switch 10. Then, HLR 20 informs a Visitor Location Register (VLR) (not shown) of whether the called party has subscribed to the service.

If the called party has subscribed to the service, then the destination switch 50 transmits the ISUP-LAM to an Information Provider (IP) 40 so that the service can be provided. At this time, the destination switch 50 transmits an Integrated Services Digital Network User Part ANswer Message (ISUP-ANM) to the originating switch 10. It then transmits an Integrated Services Digital Network User Part RELease message (ISUP-REL) to IP 40 in order to stop the service upon receiving an acknowledgement from the called party. Otherwise, if the called party has not subscribed to the service, then such service cannot be provided since the destination switch 50 does not transmit the ISUP-IAM to IP 40.

As described above, the conventional ring-back tone service can be provided only after the called party has subscribed to the service. Therefore, there is a need for providing a ring-back tone service even when only the calling party has subscribed to the ring-back tone service, wherein the service may provide music or sound that the calling party has chosen.

### DISCLOSURE OF THE INVENTION

It is, therefore, an objective of the present invention to provide a method of providing a ring-back tone service in a mobile communication system by extending such service to a calling party even when only the calling party has subscribed to the service.

In accordance with the present invention, there is provided a method of providing a ring-back tone service in a mobile communication system, wherein the ring-back tone service is subscribed to by a calling party. Such method comprises the following steps: at an originating switch, transmitting an Integrated Services digital Network User Part Initial Address Message (ISUP-IAM) to an Information provider (IP) having a server and transmitting the IAM to a destination switch; at the IP, requesting and receiving sound information from the IP server; at the IP, transmitting an Integrated Services Digital Network User Part Address Complete Message (ISUP-ACM) to the originating switch so that the ring-back tone service can be provided; and at the destination switch, transmitting an Integrated Services Digital Network User Part ANswer Message (ISUP-ANM) to the originating switch and transmitting an Integrated Services Digital Network User Part RELease message (ISUP-REL) to the IP in order to stop the ring-back tone service upon receiving an acknowledgement from a called party.

Further, in accordance with the present invention, the method of providing the ring-back tone service further comprises the following steps: at the originating switch, requesting information of the calling party to a Visitor Location Register (VLR) when a call set-up request from the calling party is established; at the originating switch, receiving information related to whether or not the ring-back tone service is activated from the VLR and determining whether the ling-back tone service can be provided or not; at the originating switch, if the ring-back tone service is not activated, processing a call procedure without providing the ring-back tone service; and at the originating switch, if the ring-back tone service is activated, connecting to the IP server to provide the ring-back tone service and then processing the call procedure.

The foregoing and other objects and features of the present invention will become more fully apparent from the following description and appended claims, taken in conjunction with the accompanying drawings.

### BRIEF DESCRIPTION OF THE DRAWINGS

It should be understood that these drawings depict only the preferred embodiments of the invention and are, therefore, not to be considered as limitations of its scope. The invention will be described with additional specificity and detail through the use of the accompanying drawings in which:

FIG. 1 shows a diagram for providing a ring-back tone service according to the prior art.

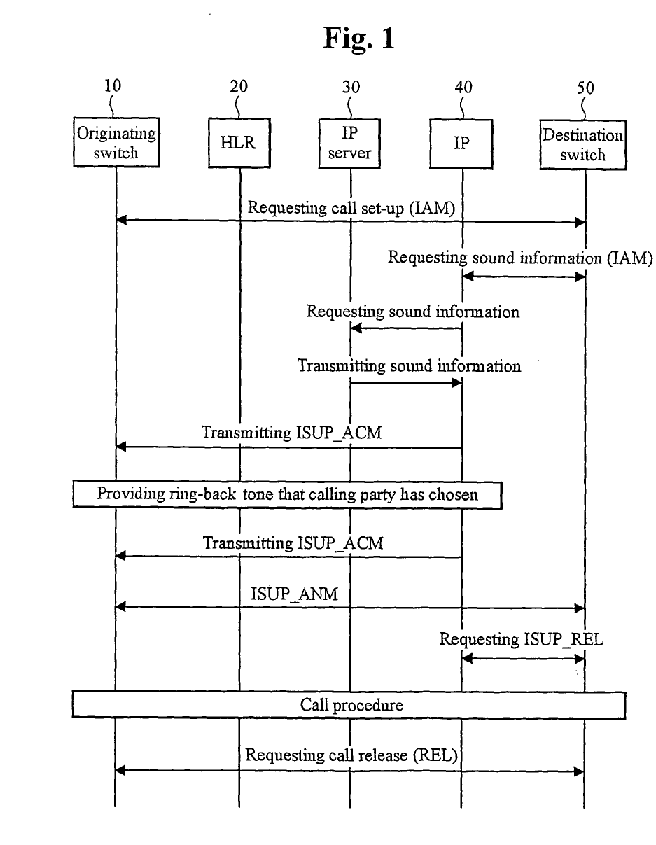

FIG. 2 shows a flowchart for providing the ring-back tone service according to the prior art.

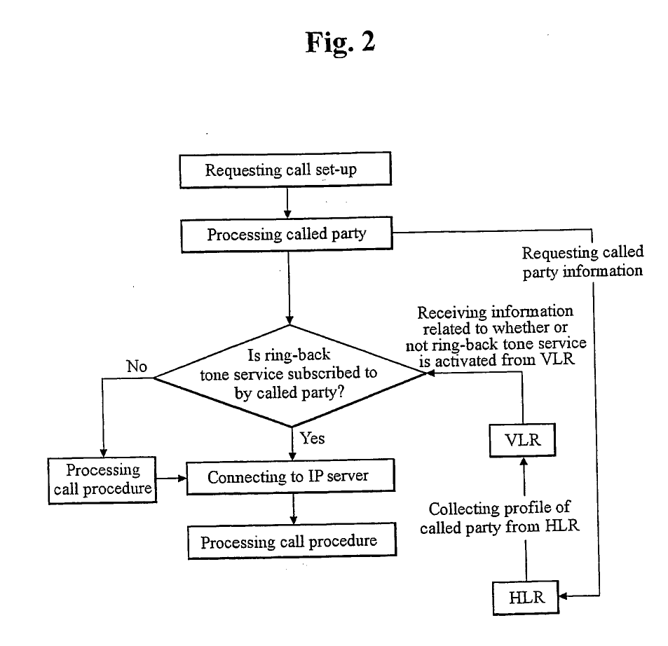

FIG. 3 shows a diagram for providing a ring-back tone service in accordance with the present invention.

FIG. 4 shows a flowchart for providing the ring-back tone service in accordance with the present invention.

### BEST MODE FOR CARRYING OUT THE INVENTION

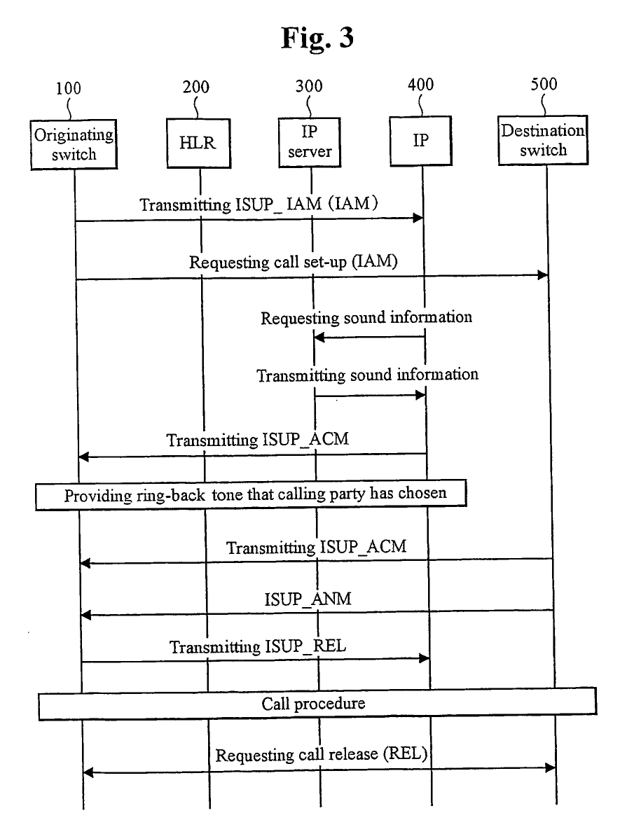

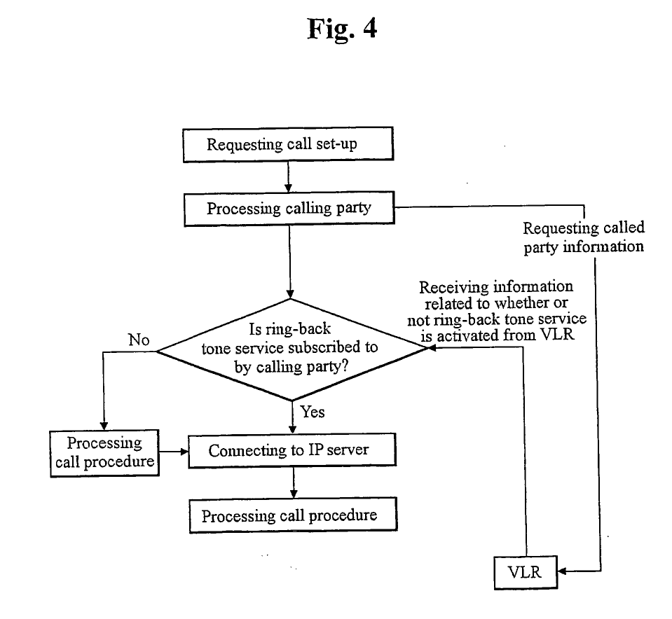

It will be readily understood that the components and steps of the present invention, as generally described and illustrated herein and in the accompanying Figures, may be arranged and designed in a wide variety of different configurations while still utilizing the inventive concept of the present invention. Thus, the detailed description of the preferred embodiments of the present invention, as described and illustrated herein and in FIGS. 3 and 4, is not intended to limit the scope of the present invention. It is merely representative of the preferred embodiments of the present invention. The preferred embodiments of the present invention will be best understood by reference to FIGS. 3 and 4, wherein certain parts or steps described herein are designated by their corresponding numerals throughout the Figures.

Referring to FIG. 3, an originating switch 100 transmits an Integrated Services digital Network User Part Initial Address Message (ISUP-IAM) to an Information Provider (IP) 400 having a server 300 and transmits the IAM to a destination switch 500. The IP 400 requests and receives sound information from the IP server 300. The IP 400 transmits an Integrated Services Digital Network User Part Address Complete Message (ISUP-ACM) to an originating switch 100 so that a ring-back tone service can be provided. The ring-back tone service is subscribed to by a calling party. The destination switch 500 transmits an Integrated Services Digital Network User Part ANswer Message (ISUP-ANM) to the originating switch 100 and transmits an Integrated Services Digital Network User Part RELease message (ISUP-REL) to the IP 400 in order to stop the ring-back tone service upon receiving an acknowledgement from a called party.

Referring to FIG. 4, the originating switch 100 requests information of the calling party to a Visitor Location Register (VLR) when a call set-up request from the calling party is established. The originating switch 100 receives information related to whether or not the ring-back tone service is activated from the VLR and determines whether the ring-back tone service can be provided or not. If the ring-back tone service is not activated, then the originating switch 100 processes a call procedure without providing the ring-back tone service. Otherwise, if the ring-back tone service is activated, the originating switch 100 connects to the IP server 300 to provide the ring-back tone service and then processes the call procedure.

As described above, in accordance with the present invention, the originating switch 100 receives the information related to whether or not the ring-back tone service is activated from the VLR before transmitting the ISUP-IAM to the destination switch 500. If the calling party has subscribed to the ring-back tone service, then the originating switch 100 transmits the ISUP-IAM to the IP 400 and destination switch 500 simultaneously, thereby performing a call set-up.

The IP 400 requests and receives the sound information from the IP server 300. Thereafter, the 400 transmits the ISUP-ACM to the originating switch 100 so that the ring-back tone service can be provided.

The destination switch 500 transmits the ISUP-ANM to the originating switch 100 and transmits the ISUP-REL to the IP 400 in order to stop the ring-back tone service, upon receiving an acknowledgement from the called party. Then, a call procedure will be processed. If the calling party has not subscribed to the ring-back tone service, then the originating switch 100 does not transmit the ISUP-IAM to the IP 400.

### INDUSTRIAL APPLICABILITY

As described above, in accordance with the present invention, there is provided a method of providing a ring-back tone service in a mobile communication system by extending such service to a calling party even when only the calling party has subscribed to the service.

Additional modifications and improvements of the present invention may also be apparent to those of ordinary skill in the art. Thus, the particular combination of parts described and illustrated herein is intended to represent only certain embodiments of the present invention, and is not intended to serve as limitations of alternative devices within the spirit and scope of the invention.

1. A method of providing a ring-back tone service in a mobile communication system, wherein the ring-back tone service is subscribed to by a calling party, the method comprising the steps of:
at an originating switch, transmitting an Integrated Services digital Network User Part Initial Address Message (ISUP-LAM) to an Information provider (IP) having a server and transmitting the IAM to a destination switch;
at the IP, requesting and receiving sound information from the IP server;
at the IP, transmitting an Integrated Services Digital Network User Part Address Complete Message (ISUP-ACM) to the originating switch so that the ring-back tone service can be provided; and
at the destination switch, transmitting an Integrated Services Digital Network User Part ANswer Message (ISUP-ANM) to the originating switch and transmitting an Integrated Services Digital Network User Part RELease message (ISUP-REL) to the IP in order to stop the ring-back tone service upon receiving an acknowledgement from a called party.

2. The method of claim 1, further comprising:
at the originating switch, requesting information of the calling party to a Visitor Location Register (VLR) when a call set-up request is established;
at the originating switch, receiving information related to whether or not the ring-back tone service is activated from the VLR and determining whether the ring-back tone service party can be provided or not;
at the originating switch, if the ring-back tone service is not activated, processing a call procedure without providing the ring-back tone service; and
at the originating switch, if the ring-back tone service is activated, connecting to the IP server to provide the ring-back tone service and then processing the call procedure.
